(19) United States
(12) Patent Application Publication
(10) Pub. No.: US 2016/0350792 A1
(43) Pub. Date: Dec. 1, 2016

(54) SYSTEMS AND METHODS FOR SIMULATING REWARD OPPORTUNITIES

(71) Applicant: Capital One Services, LLC, McLean, VA (US)

(72) Inventors: Arun RAJAPPA, Glen Allen, VA (US); David FREI, Glen Allen, VA (US)

(21) Appl. No.: 15/165,052

(22) Filed: May 26, 2016

Related U.S. Application Data
(60) Provisional application No. 62/166,282, filed on May 26, 2015.

(51) Int. Cl. G06Q 30/02

(52) U.S. Cl. CPC G06Q 30/0233; G06Q 30/0236

(57) ABSTRACT

System and methods are provided for simulating reward opportunities of a plurality of reward accounts. The system may comprise a memory device(s) storing instructions, and a processor(s) configured to execute the instructions to perform operations. The processor(s) may be configured to generate an interface for display to a user, access spending information corresponding to a plurality of transactions, access reward term information corresponding to a plurality of reward accounts based on a comparison parameter, index the spending information according to categories of spending based on the reward term information, simulate a reward opportunity for each of the reward accounts based on the indexed spending information, generate a comparison metric for each of the reward accounts based in part on the reward term information and the simulated reward opportunity, and update the interface to display the comparison metrics and information corresponding to the simulated reward opportunities.

### PRIORITY CLAIM

This disclosure claims priority under 35 U.S.C. §119 to U.S. provisional patent application No. 62/166,282, filed on May 26, 2015. The aforementioned application is incorporated herein by reference in its entirety.

### TECHNICAL FIELD

The disclosed embodiments generally relate to systems and methods for simulating reward opportunities based on historical spending data.

### BACKGROUND

Financial service providers currently offer a diverse set of incentives to customers or potential customers for opening and maintaining a financial service account, such as one associated with a debit card or credit card. For example, incentives may include reward points, cash back, and other incentives, based on a customer's use of the account for a plurality of purchase transactions. Various financial service providers may allow redemption of reward points across numerous categories of goods and services including general merchandise, gift cards, hotels, flights, entertainment, etc. The amount of reward points, cash back percentage, and other such incentives vary by financial service provider and even between products of a single financial service provider. Each of the financial service accounts may also include different terms and conditions related to an annual fee, spending limits, qualifying purchases in certain categories of goods, etc. Such diversity in rewards and terms associated with a financial service account make it difficult for customers to choose the best account or reward card for their spending habits and needs. There currently is no system that enables users to identify and compare reward opportunities based on their own historical spending data.

Thus, there is a need for improved methods and systems for identifying reward opportunities associated with a plurality of financial service accounts. Moreover, there is a need for simulating the reward opportunities based on historical spending data unique to the customer.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

The present disclosure provides systems and methods for enabling customers or potential customers to identify and compare credit card (or other financial service account) rewards based on historical spending information. Thus, embodiments of the present disclosure improve existing systems by, among other things, identifying a desired financial service account uniquely suited to a user. In some embodiments, a customer may be presented with an interface for receiving an upload of historical spending information or otherwise providing access to historical spending information of an existing account. The interface may provide a plurality of customizable options for selecting one or more characteristics of a rewards program that may interest the customer. In some embodiments, back-end computing systems may analyze the historical spending information and simulate the rewards that may have been earned with a particular financial service account based on the customer's historical spending information. The interface may also enable a user to compare the simulated reward information for a plurality of financial service accounts. In some embodiments, back-end computing systems may determine a comparison metric based on one or more categories of a reward. The comparison metric may provide a basis for comparing a reward value among the plurality of financial service accounts. Additional aspects of the disclosed embodiments are set forth below in this disclosure.

System and methods are provided for simulating reward opportunities of a plurality of reward accounts. For example, the system may comprise one or more memory devices storing instructions provided as part of a reward simulating application, and one or more processors may be configured to execute the instructions to generate an interactive graphical user interface for display to a user of a computing device, to access spending information corresponding to a plurality of transactions completed using a financial account associated with a user, and access reward term information corresponding to a plurality of reward accounts associated with a comparison parameter based on received user input of one or more parameters. The one or more processors may also be configured to index the spending information according to one or more categories of spending based on the reward term information for each of the plurality of reward accounts, simulate a reward opportunity for each of the plurality of reward accounts based on the indexed spending information and the reward term information, generate a comparison metric for each of the plurality of reward accounts based in part on the reward term information and the simulated reward opportunity, the comparison metric identifying a common basis for comparison among the plurality of reward accounts, and update the graphical user interface to display the comparison metrics and information corresponding to the simulated reward opportunities.

The disclosed embodiments also include a method for simulating reward opportunities of a plurality of reward accounts. The method may include generating an interactive graphical user interface for display to a user of a computing device, accessing spending information corresponding to a plurality of transactions completed using a financial account, and accessing reward term information corresponding to a plurality of reward accounts associated with a comparison parameter based on received user input of one or more comparison parameters. The method may also include indexing the spending information according to one or more categories of spending based on the reward term information for each of the plurality of reward accounts, simulating a reward opportunity for each of the plurality of reward accounts based on the indexed spending information and the reward term information, generating a comparison metric for each of the plurality of reward accounts based in part on the reward term information and the simulated reward opportunity, the comparison metric identifying a common basis for comparison among the plurality of reward accounts, and updating the graphical user interface to display the comparison metrics and information corresponding to the simulated reward opportunities.

The disclosed embodiments may further include a computer readable medium storing instructions executable by a processor to cause the processor to perform a method that includes generating an interactive graphical user interface for display to a user of a computing device, accessing spending information corresponding to a plurality of transactions completed using a financial account, and accessing reward term information corresponding to a plurality of reward accounts associated with a comparison parameter based on received user input of one or more comparison parameters. The method may also include indexing the spending information according to one or more categories of spending based on the reward term information for each of the plurality of reward accounts, simulating a reward opportunity for each of the plurality of reward accounts based on the indexed spending information and the reward term information, generating a comparison metric for each of the plurality of reward accounts based in part on the reward term information and the simulated reward opportunity, the comparison metric identifying a common basis for comparison among the plurality of reward accounts, and updating the graphical user interface to display the comparison metrics and information corresponding to the simulated reward opportunities.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary system, consistent with the disclosed embodiments;

FIG. 2 is a block diagram of an exemplary computer system, consistent with the disclosed embodiments;

FIG. 3 is a flowchart of an exemplary process for identifying reward opportunities based on historical spending data, consistent with the disclosed embodiments;

FIG. 4 is a flowchart of an exemplary reward identification process, consistent with the disclosed embodiments;

FIG. 5 is a flowchart of an exemplary comparison metric generation process, consistent with the disclosed embodiments; and

FIG. 6 is an example of an exemplary interface, consistent with the disclosed embodiments.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts.

The present disclosure describes, among other things, advantageous reward identification systems and methods for identifying and comparing financial service account rewards for a customer based on historical spending data. For example, the disclosed embodiments provide computing systems and methods for evaluating and comparing simulated reward offerings of a plurality of financial service accounts based on historical spending information of a user. The disclosed computing systems may provide an interface for receiving uploads of historical spending information and receiving selections of one or more characteristics of a plurality of reward offerings to identify a desirable financial service account based on the simulated reward offerings. In some embodiments, disclosed systems may supplement historical spending information with projected spending information for a future period, such as when certain significant purchases may be planned, received via the interface.

In some embodiments, the disclosed systems and methods may provide a comparison of financial service account reward offerings of the same or similar category, such as cash back, points, miles, etc. For example, disclosed systems and methods may compare reward programs offering cash back rewards. The disclosed systems and methods may generate an interface comparing simulated cash back rewards of a plurality of financial service accounts that would have been earned based on the customer's historical spending information. In other embodiments, the disclosed systems and methods may compare the value of reward offerings across one or more categories. For example, the disclosed systems and methods may generate a comparison metric that provides a common basis to compare the value of potential rewards associated with one or more financial service accounts. Extending the example above, disclosed systems may receive a selection of compared reward programs offering cash back and/or points that may be redeemed for a gift card, for example. The disclosed systems and methods may generate a comparison metric based on a conversion of simulated reward points to a value of a gift card redeemable using the points. Thus, disclosed systems and methods may indicate which of the financial service accounts would provide a greater value based on the comparison metric. Other analysis of historical spending data and comparisons across financial service account rewards programs may be enabled by the disclosed systems as described in further detail below.

Thus, the disclosed systems and methods may identify which of a plurality of financial service accounts may provide desired reward offerings based on a user's actual spending patterns. In some embodiments, the disclosed systems and methods may also be implemented to monitor the current benefits earned using a financial service account and identify whether other financial service accounts may provide more desirable benefits.

The following disclosure provides additional discussion of exemplary systems and methods for identifying reward opportunities based on historical spending data.

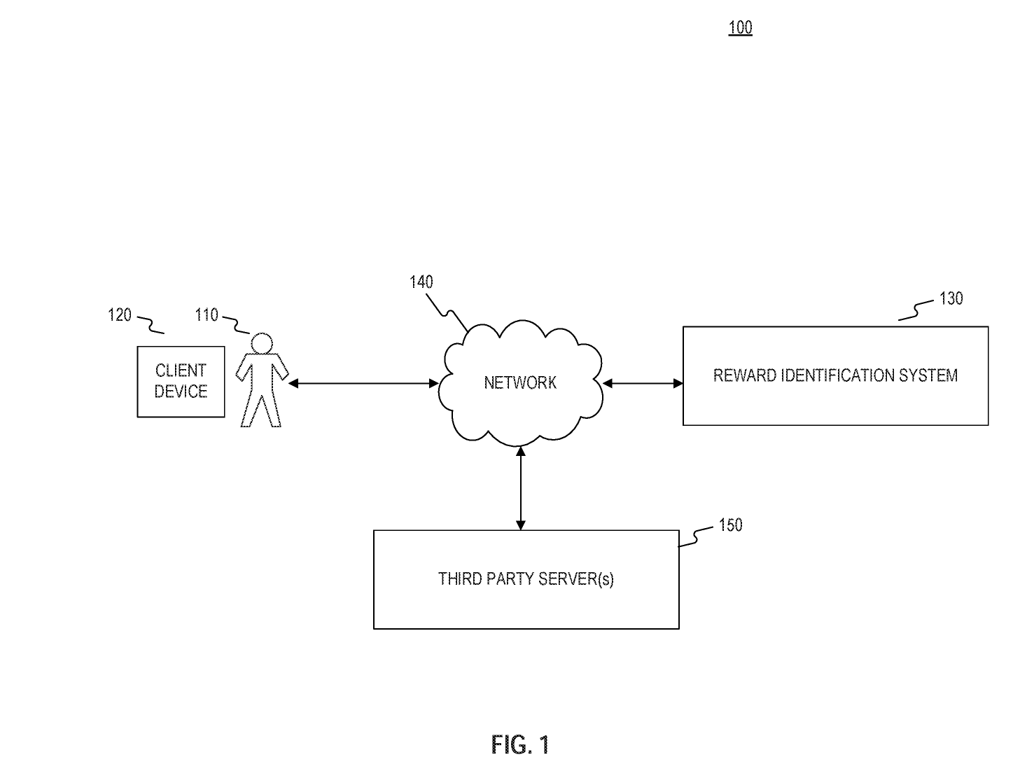

FIG. 1 shows a diagram of an exemplary system 100 that may be configured to identify potential reward opportunities based on historical spending data, consistent with disclosed embodiments.

As shown in FIG. 1, system 100 may include a client device 120 associated with a customer 110, a reward identification system 130, one or more third party servers 150, and a network 140 to facilitate communication among the components of system 100. The components and arrangement of the components included in system 100 may vary. Thus, system 100 may further include other components that perform or assist in the performance of one or more processes consistent with the disclosed embodiments. The components and arrangements shown in FIG. 1 are not intended to limit the disclosed embodiments, as the components used to implement the disclosed processes and features may vary.

In accordance with disclosed embodiments, system 100 may include a reward identification system 130. In some embodiments, reward identification system 130 may be a system associated with a financial service provider (not shown), such as a bank, a credit card company, a lender, brokerage firm, or other type of financial service entity that generates, provides, manages, and maintains financial service accounts for one or more customers 110. Reward identification system 130 may include one or more computing systems that are configured to execute software instructions stored on one or more memory devices to perform one or more operations consistent with the disclosed embodiments. For example, reward identification system 130 may include one or more memory device(s) storing data and software instructions, and one or more processor(s) configured to use the data and execute the software instructions to perform server-based functions and operations known to those skilled in the art. Reward identification system 130 may include one or more special purpose computers configured to perform a specific task, mainframe computers, embedded systems, or any combination of these types of components.

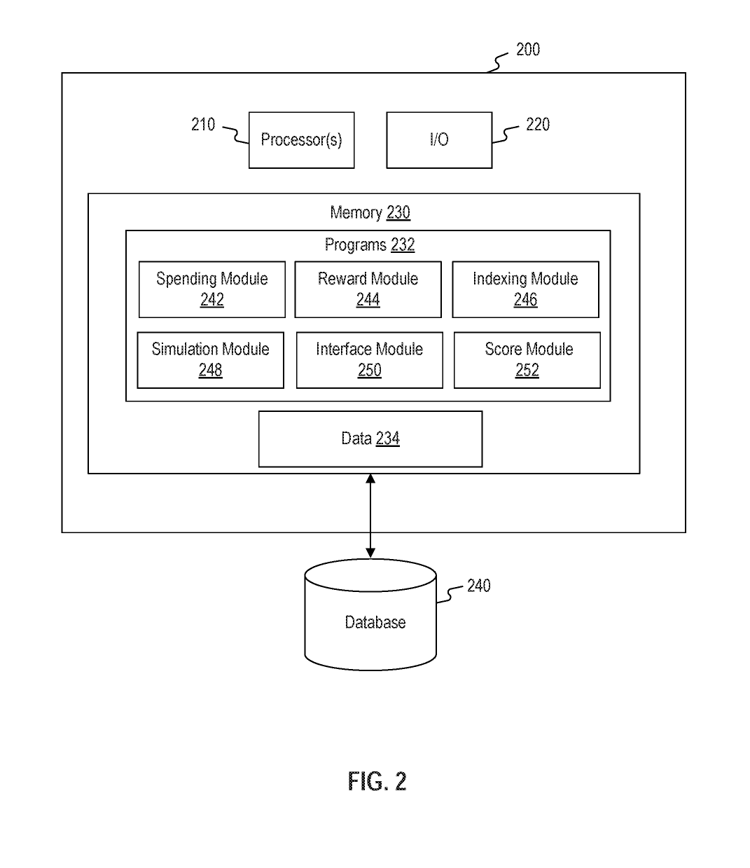

In certain embodiments, reward identification system 130 may be configured as a particular apparatus, system, and the like, based on the storage, execution, and/or implementation of the software instructions that perform one or more operations consistent with the disclosed embodiments. Reward identification system 130 may be standalone, or it may be part of a subsystem, which may be part of a larger system. For example, reward identification system 130 may represent distributed servers that are remotely located and communicate over a public network (e.g., network 140) or a dedicated network, such as a LAN, for a financial service provider. An exemplary computing system consistent with reward identification system 130 is discussed in additional detail with respect to FIG. 2, below.

Reward identification system 130 may include or may access one or more storage devices configured to store data and/or software instructions used by one or more processors of reward identification system 130 to perform operations consistent with disclosed embodiments. For example, reward identification system 130 may include memory configured to store one or more software programs that perform several functions when executed by a processor, including functions specific to the disclosed reward identification methods. The disclosed embodiments are not limited to separate programs or computers configured to perform dedicated tasks. For example, reward identification system 130 may include memory that stores a single program or multiple programs. Additionally, reward identification system 130 may execute one or more programs located remotely from reward identification system 130. For example, reward identification system 130 may access one or more remote programs stored in memory included with a remote component that, when executed, perform operations consistent with the disclosed embodiments.

In certain aspects, reward identification system 130 may include one or more web servers that execute software that generates, maintains, and provides web site(s) including an exemplary interface of the disclosed systems and methods. In other aspects, a reward identification system 130 may connect separately to web server(s) or similar computing devices that generate, maintain, and provide web site(s) for presenting an exemplary interface of the disclosed systems and methods.

System 100 may also include one or more third party servers 150. Third party servers 150 may include one or more computing systems that are associated with one or more entities having access to customer information, including financial information. For example, third party servers 150 may be associated with other financial service providers (not shown), such as a bank, a credit card company, a lender, brokerage firm, or any other type of financial service entity that generates, provides, manages, and maintains financial service accounts for one or more customers 110. Moreover, third party servers 150 may include or may access one or more storage devices configured to store historical spending data, financial service account information, reward program offerings, and other data regarding terms and conditions of a financial service account offered by the associated financial service providers.

Third party servers 150 may also store one or more sets of software instructions used by one or more processors to perform operations consistent with disclosed embodiments and other server based functions. In certain embodiments, third party servers 150 may be configured as a particular apparatus, system, and the like, based on the storage, execution, and/or implementation of the software instructions that perform one or more operations consistent with the disclosed embodiments. Third party servers 150 may be standalone, or they may be part of a subsystem, which may be part of a larger system. For example, third party servers 150 may represent distributed servers that are remotely located and communicate over a public network (e.g., network 140) or a dedicated network, such as a LAN. An exemplary computer system consistent with third party servers 150 is discussed in additional detail with respect to FIG. 2.

System 100 may further include one or more client devices 120. A customer or potential customer 110 may operate a client device 120, which may be a desktop computer, laptop, tablet, smartphone, multifunctional watch, pair of multifunctional glasses, or any suitable device with computing capability. Client device 120 may also include or otherwise be connectable to a display or other means for providing an interface according to the disclosed embodiments. Client device 120 may have a reward identification application installed thereon, which may enable client device 120 to communicate with reward identification system 130 via network 140 and perform aspects of the disclosed reward identification methods. Alternatively, client device 120 may connect to reward identification system 130 and/or third party servers 150 through use of browser software. Client device 120 may allow customer 110 to access information stored in third party servers 150, such as, for example, financial information related to historical spending information, rewards program information and the like. Client device 120 may also be configured to enable customer 110 to enter a purchase or payment transaction as a remote or mobile payment device.

Client device 120 may include one or more computing systems that are configured to execute software instructions stored on one or more memory devices to perform one or more operations consistent with the disclosed embodiments. For example, client device 120 may include one or more memory device(s) storing data and software instructions, and one or more processor(s) configured to use the data and execute the software instructions to perform aspects of the disclosed embodiments and other operations known to those skilled in the art.

Network 140 may comprise any type of computer networking arrangement used to exchange data. For example, network 140 may be the Internet, a private data network, a virtual private network using a public network, a Wi-Fi network, a LAN or WAN network, and/or other suitable connections that may enable information exchange among various components of system 100. Network 140 may also include a public switched telephone network (“PSTN”) and/or a wireless cellular network. Network 140 may be a secured network or unsecured network. In other embodiments, one or more components of system 100 may communicate directly through a dedicated communication link(s), such as links between reward identification system 130 and third party servers 150.

Other components known to one of ordinary skill in the art may be included in system 100 to process, transmit, provide, and receive information consistent with the disclosed embodiments. In addition, although not shown in FIG. 1, components of system 100 may communicate with each other through direct communications, rather than through network 140. Direct communications may use any suitable technologies, including close range communication protocols, such as those employed under the name BLUETOOTH™ or BLUETOOTH LE™, and Wi-Fi, or any known near field communications (NFC) techniques, or other suitable communication methods that provide a medium for transmitting data between separate devices.

In one aspect, customer 110 may be a customer (or a potential customer) of a financial service provider associated with reward identification system 130 or one or more third party servers 150. For instance, a financial service provider associated with reward identification system 130 or third party servers 150 may maintain a financial service account (e.g., credit card account, checking account, etc.) that the customer 110 may use in a plurality of transactions, such as, for example, a purchase of goods and/or services online or at brick and mortar locations associated with a merchant. A financial service provider associated with the financial service account may store the transaction information as historical spending information. The historical spending information may be stored in a third party server 150 or as part of reward identification system 130 associated with the financial service provider.

Consistent with disclosed embodiments, client device 120 may communicate with reward identification system 130 to perform aspects of the disclosed embodiments. In some embodiments, client device 120 may access historical spending information associated with customer 110 operating client device 120. Client device 120 may also provide the historical spending information to reward identification system 130. Reward identification system 130 may perform certain aspects of the disclosed embodiments based on the received historical spending information. Further, client device 120 may display a financial service account or financial statement provided by a financial service provider, and perform other operations associated with the financial service account, including registration operations for registering customer 110 with a new financial service account, etc.

FIG. 2 shows a diagram of an exemplary computing system 200, consistent with the disclosed embodiments.

In some embodiments, computing system 200 may include one or more processors 210, one or more memories 230, and one or more input/output (I/O) devices 220. In some embodiments, computing system 200 may take the form of a server, one or more special purpose computers, a mainframe computer, laptop, or any combination of these or other computing components. In certain embodiments, computing system 200 (or a system including computing system 200) may be configured as a particular apparatus, system, and the like based on the storage, execution, and/or implementation of the software instructions that perform one or more operations consistent with the disclosed embodiments. Computing system 200 may include a plurality computing subsystems performing one or more of the disclosed functions or other dedicated tasks. Computing system 200 may be standalone, or it may be part of a subsystem, which may be part of a larger system.

I/O devices 220 may be one or more devices configured to allow data to be received and/or transmitted by computing system 200. I/O devices 220 may include one or more digital and/or analog communication devices that allow computing system 200 to communicate with other machines and devices, such as other components of system 100 shown in FIG. 1. Computing system 200 may also include interface components for one or more input devices, such as one or more keyboards, mouse devices, and the like, which may enable computing system 200 to receive input from an operator of FSP system 130 (not shown).

Processor 210 may include one or more known processing devices, such as a microprocessor from the Pentium™ or Xeon™ family manufactured by Intel™, the Turion™ family manufactured by AMD™, or any of various processors manufactured by Sun Microsystems, for example. Processor 210 may constitute a single core or multiple core processor that executes parallel processes simultaneously. For example, in one embodiment, processor 210 may be a single core processor configured with virtual processing technologies. In certain embodiments, processor 210 may use logical processors to simultaneously execute and control multiple processes. Processor 210 may implement virtual machine technologies, or other known technologies to provide the ability to execute, control, run, manipulate, store, etc. multiple software processes, applications, programs, etc. In another embodiment, processor 210 may include a multiple-core processor arrangement (e.g., dual, quad-core, etc.) configured to provide parallel processing functionalities to allow computing system 200 to execute multiple processes simultaneously. One of ordinary skill in the art would understand that other types of processor arrangements could be implemented that provide for the capabilities disclosed herein. The disclosed embodiments are not limited to any type of processor(s) configured in computing system 200.

Memory 230 may include one or more storage devices configured to store instructions executable by processor 210 to perform functions related to the disclosed embodiments. Memory 230 may be a volatile or non-volatile, magnetic, semiconductor, tape, optical, removable, non-removable, or other type of storage device or tangible (i.e., non-transitory) computer-readable medium. Memory 230 may be configured with one or more software instructions, such as one or more program(s) 232 that perform particular functions when executed by processor 210. The disclosed embodiments are not limited to separate programs or computers configured to perform dedicated tasks. For example, memory 230 may include a set of programs 232 that perform the functions of computing system 200, or programs 232 could comprise a single program and one or more submodules for performing dedicated tasks. Additionally, processor 210 may execute one or more programs located remotely from computing system 200.

Client device 120, reward identification system 130, and/or third-party server 150 may, via one or more separate computing systems 200 (or variants thereof), access one or more remote programs that, when executed, perform functions related to certain disclosed embodiments. Processor 210 may further execute one or more programs located in database 240. In some embodiments, programs 232 may be stored in an external storage device, such as a cloud server located outside of computing system 200, and processor 210 may execute programs 232 remotely.

Programs 232 executed by processor 210 may cause processor 210 to execute one or more processes related to the disclosed reward identification methods including receiving historical spending information, receiving financial service account terms and conditions, indexing spending information based on the received terms and conditions, simulating reward earning opportunities based on the historical spending information, generating a comparison metric, and generating and displaying an interface comparing identified reward opportunities, as well as other operations related to the disclosed methods. As indicated above, the one or more processes may be executed based on one or modules or submodules comprising a set of instructions for performing aspects of the disclosed systems. In some embodiments, the processes may be executed based on instructions provided as part of spending module 242, reward module 244, indexing module 246, simulation module 248, interface module 250 and score module 252. These and other aspects of the exemplary systems and methods are described in greater detail below. In some embodiments, memory 230 may also store instructions to enable processor 210 to execute an operating system and/or one or more other applications, such as server applications, network communication processes, and any other type of application or software.

In general, the word “module,” as used herein, refers to a collection of software instructions written in a programming language, such as, for example, Java, Lua, C or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. A module “configured to” perform a given function generally includes programming instructions that provide the described functions when executed by a processor 210. Software modules configured for execution on computing devices can be provided on a computer readable medium, such as a compact disc, digital video disc, flash drive, magnetic disc, or any other tangible medium, or as a digital download (and can be originally stored in a compressed or installable format that requires installation, decompression, or decryption prior to execution). The modules or computing device functionality described herein are preferably implemented as software modules, but can be represented in hardware or firmware. Generally, the modules described herein refer to logical modules that can be combined with other modules or divided into sub-modules despite their physical organization or storage.

Memory 230 may also store data 234 that may reflect any type of information in any format that the computing system 200 may use to perform operations consistent with the disclosed embodiments. Data 234 may include historical spending information related to purchase or payment transactions initiated by customer 110. For example, data 234 may include a plurality of data records corresponding to a plurality of customers 110. The data records may include an account or customer identifier and purchase transaction information including amounts and identifiers of the goods purchased. Data 234 may also include a plurality of data records corresponding to various terms and conditions and other reward program information associated with a plurality of financial service accounts. Various terms and conditions information may identify particular reward program information associated with a financial service account such as the amount of an annual fee, various requirements or qualifications for earning rewards, information regarding the amount of rewards earned, and other information that may be used by computing system to simulate potential reward opportunities based on historical spending information.

In some embodiments, data 234 and/or programs 232 and other information may be stored in or accessed from one or more database(s) 240. Computing system 200 may include database 240 or alternatively may be communicatively connected to one or more database(s) 240. Computing system 200 may be communicatively connected to database(s) 240 through network 140. Database 240 may include one or more memory devices that store information and are accessed and/or managed through computing system 200. By way of example, database(s) 240 may include Oracle™ databases, Sybase™ databases, or other relational databases or non-relational databases, such as Hadoop™ sequence files, MongoDB™, HBase™, or Cassandra™. Database 240 may include computing components (e.g., database management system, database server, etc.) configured to receive and process requests for data stored in memory devices of database(s) 240 and to provide data from database 240.

As discussed above, client device 120, reward identification system 130, and/or third party servers 150 may include at least one computing system 200. Thus, although sometimes discussed herein with respect to reward identification system 130, it should be understood that variations of computing system 200 may be used by other components of system 100, including third party servers 150 and client device 120. Computing system 200 may be a single server or may be configured as a distributed computer system including multiple servers or computers that interoperate to perform one or more of the processes and functionalities associated with the disclosed embodiments.

As indicated above, in some aspects, third party servers 150 and client device 130 may include a similar configuration and/or some of the components of computing system 200. Computing system 200 when implemented in third party servers 150 may include any hardware and/or software installed therein necessary for performing methods and processes of the disclosed embodiments, such as for example, the operations associated with a financial service account rewards program including maintenance of historical spending information. Additionally, client device 120 may also include any hardware and/or software installed therein necessary for displaying an interface to customer 110, receiving user input and communicated with other components of system 100, as well as other operations disclosed in the exemplary embodiments.

The following processes are directed to, among other things, various embodiments for identifying reward opportunities based on historical spending information that may be performed by aspects and components of system 100 and computing system 200 as is apparent from the disclosure.

According to some embodiments, disclosed systems and methods may identify potential reward opportunities presented by one or more financial service provider accounts or products. In the exemplary embodiments, client device 120 may provide an interface on a display of client device 120, and receive input from customer 110 interacting with the displayed interface, to provide historical spending information and customize a comparison of potential reward opportunities based at least in part on the customer's historical spending information.

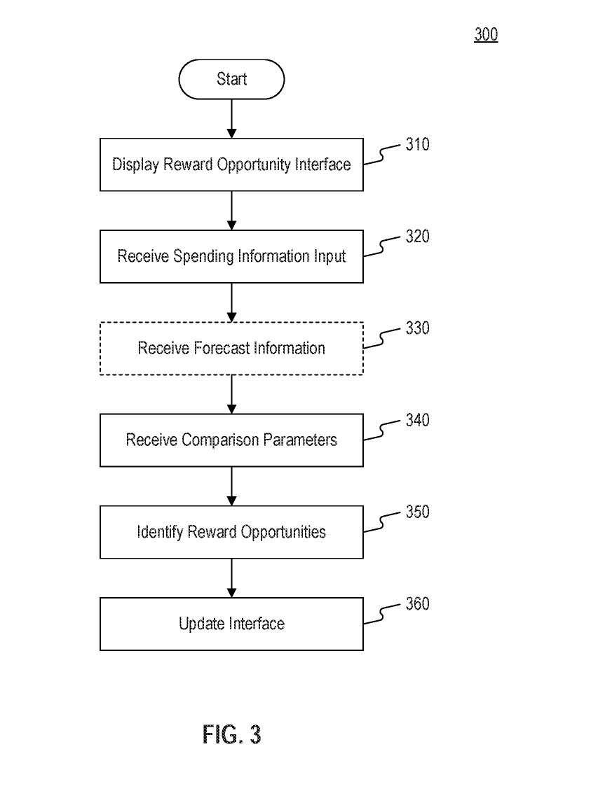

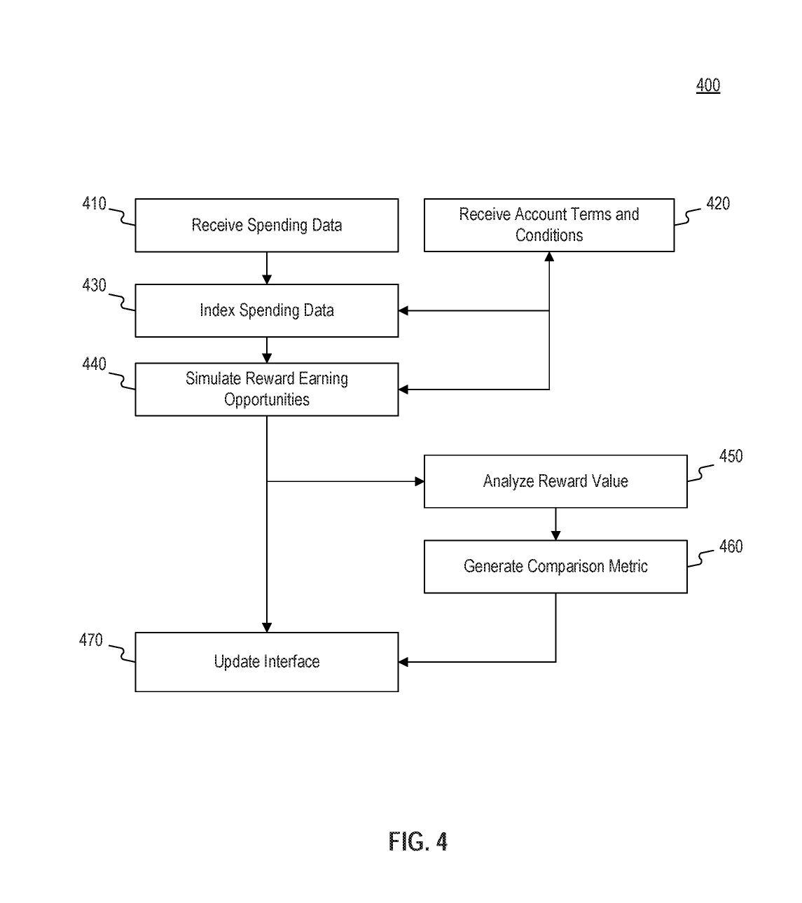

FIG. 3 shows an exemplary process 300 for initiating a reward opportunity identification process 400 described below with respect to FIG. 4. Certain aspects of process 300 may be implemented by one or more software programs executed as an application on, for example, client device 120 or otherwise accessible via a browser application on client device 120. It is to be understood that one or more other underlying aspects of process 300 may be implemented by other components of system 100 (shown or not shown), including reward identification system 130 configured to provide certain information for display in an exemplary interface on client device 120 and for communicating reward opportunities to client device 120, for example.

A first operation 310, executed by a software application on client device 120, may provide a reward opportunity interface via a display of client device 120, for example. Operation 310 may be performed in response to a request to identify potential reward opportunities. In some embodiments, a request may be received via user input to client device 120 as an interaction with an application or browser executed on client device 120, for example. In some embodiments, the exemplary reward opportunity interface may be associated with a financial service provider and accessed within a financial service provider application or interface. In other embodiments, the exemplary reward opportunity interface may be provided as part of a standalone service.

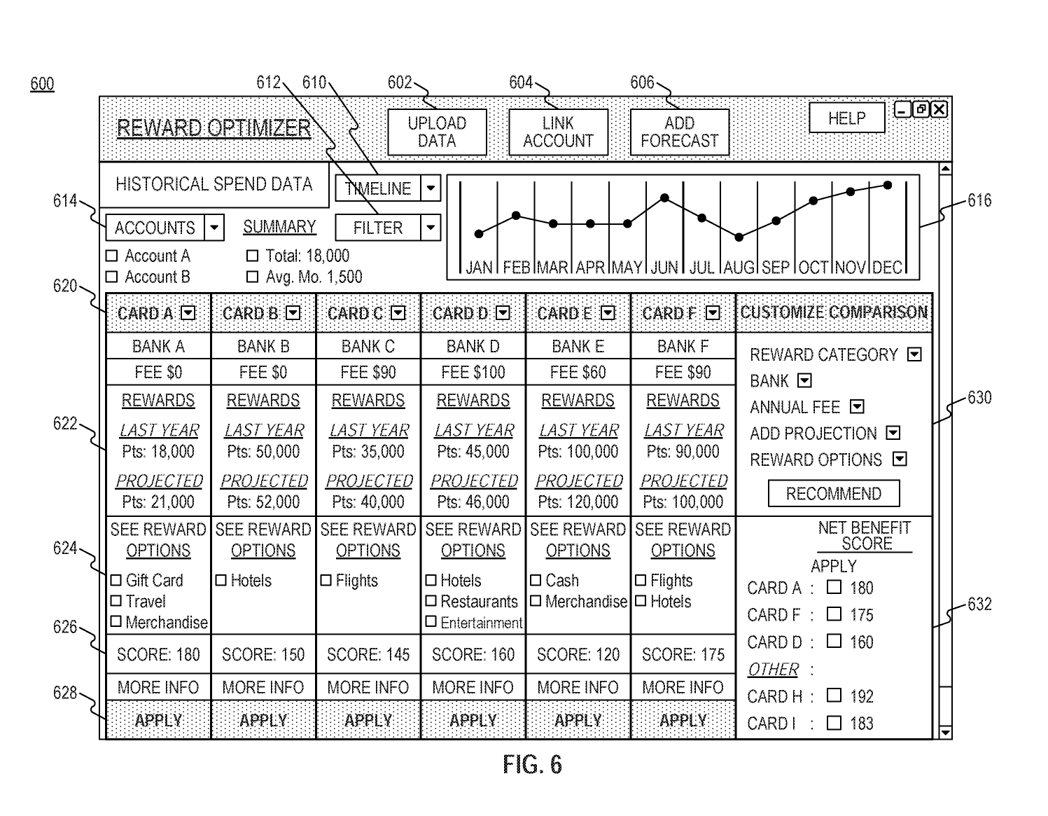

In some embodiments, an exemplary reward opportunity interface may enable a customer (or potential customer) 110 to provide input of historical spending information and other information for customizing a reward opportunity comparison of the exemplary embodiments. An example interface illustrating an exemplary reward opportunity comparison is shown in FIG. 6, which is described in further detail below. A similar interface may be displayed as part of operation 310. As part of operation 320, an exemplary application or browser executed by client device 120 may receive spending information input from customer 110 via the reward opportunity interface. Spending information input may correspond to historical spending information uploaded by customer 110, or in some embodiments it may correspond to various credential information for accessing historical information.

For example, in some embodiments, client device 120 may be able to directly upload historical spending information upon receiving customer 110's selection of an interactive button or link provided as part of the reward opportunity interface 600. For example, as shown in FIG. 6, an exemplary reward opportunity interface 600 may include a selectable link or button 602 for uploading historical spending information. In other embodiments, client device 120 may provide reward identification system 130 access to one or more financial service accounts containing historical spending information based on information inputted by customer 110 operating client device 120. Access may be provided by linking an existing account with reward identification system 130 by, for example, providing reward identification system 130 access to historical spending information of customer 110 stored in other system memory devices. As shown in FIG. 6, a selectable button 604 may be provided as part of reward opportunity interface 600 for receiving a selection by customer 110 (via, e.g., client device 120) to link one or more financial service accounts for providing access to historical spending information.

In the disclosed embodiments, historical spending information may correspond to any prior or current spending information of customer 110 for any predetermined period of time. Historical spending information may include information from the previous month, previous year, etc. Spending information may also correspond to information associated with one or more types of accounts or spending methods, such as a checking account, debit card, credit card, or other financial service accounts. In some embodiments, spending information may be received and aggregated from a plurality of financial service accounts. In the disclosed embodiments, historical spending information may correspond to any information that may be relevant for the exemplary reward identification methods to determine potential reward opportunities that may have been available to customer 110 based on the customer's spending habits. In some embodiments, historical spending information may also include credit payment information, which may be distinct from spending information in that it reflects, for example, customer 110's payments towards a credit balance. Such information may be useful to determine potential rewards when, for example, rewards points are earned at least in part based on customer 110's payment amounts instead of (or in addition to) customer 110's spending amounts.

Additionally or alternatively, in some embodiments, client device 120 may optionally receive an input of forecast information (step 330) from customer 110 via an exemplary reward opportunity interface, such as via selectable button 606 shown in FIG. 6. Forecast information may correspond to any information related to forecasted spending by customer 110. In the disclosed embodiments, forecast information may be used to supplement a customer's historical spending information based on anticipated events or changes in spending habits. By inputting forecast information, identification of potential reward opportunities may be updated to reflect potential rewards based on likely spending habits in the future. For example, customer 110 may be able to identify potential reward opportunities tailored to a particular upcoming scenario, such as the birth of a child, or a child leaving the household, a move to a new location, purchase of an automobile, increased travel, furnishing a home, etc. Any number of life situations that may affect one's spending habits may be considered as part of forecast information. In some embodiments, forecast information may include an estimate of increased or decreased spending, whereas in other embodiments, forecast information may correspond to information regarding the life situation or change in a spending habit. In some embodiments, one or more aspects of reward identification system 130 may be configured to determine an estimate for the change in customer 110's spending based on the information regarding the life situation provided by customer 110. In some embodiments, forecast information may also enable reward identification system 130 to identify potential financial service account recommendations to increase customer 110's benefits from a reward program.

In operation 340, client device 120 may receive an input of one or more comparison parameters via an exemplary reward opportunity interface 600, such as that shown in FIG. 6. The one or more comparison parameters may correspond to any information relevant to determining potential reward opportunities. In some embodiments, one or more comparison parameters may correspond to a period of time for which historical spending information should be considered, or from which account of a plurality of financial service accounts should spending information be considered. Additionally, in some embodiments, one or more comparison parameters may correspond to information concerning a desired rewards program associated with a financial service account. For example, in some embodiments, one or more comparison parameters may correspond to an identification of a particular rewards category (such as cash back, miles, or points), an identifier of a particular financial service provider (such as the name of a bank or credit card processor), whether accounts with an annual fee or other reward options (such as the nature of goods or services that may be redeemed with reward points) should be considered, and the identity of a merchant or other organization associated with a financial service account. Other similar comparison metrics are also contemplated by the present disclosure.

Once a customer 110 has provided the relevant spending information, forecast information, and comparison parameters, operation 350 may be performed to identify or simulate reward opportunities based on the historical spending information. Operation 350 may be performed in part by a computing system 200 associated with a reward identification system 130. As part of operation 350, client device 120 may transmit, via network 140, for example, the received spending information, forecast information, and comparison parameters to reward identification system 130 as part of a reward opportunity request message or other communication requesting identification of reward opportunities. Various aspects of a computing system 200 associated with reward identification system 130 may receive the reward opportunity request message and perform one or more operations to identify potential reward opportunities. Additional aspects of operation 350 are described in further detail below with respect to process 400 shown in FIG. 4.

In operation 360, an exemplary reward opportunity interface may be updated based on the identified reward opportunities. As part of operation 360, client device 120 may receive reward opportunity information from reward identification system 130. The nature and content of the received reward opportunity information may vary based on a particular embodiment. For example, in some embodiments, client device 120 may receive reward opportunity information that may be used to update aspects of an exemplary interface displayed by client device 120. In other embodiments, client device 120 may receive information regarding the updated interface itself. Other variations of reward opportunity information may be received to enable client device 120 to provide an updated interface displaying reward opportunity information. Aspects of an exemplary updated interface are discussed in greater detail below with respect to FIG. 6.

FIG. 4 illustrates an exemplary process 400 for identifying reward opportunities consistent with the disclosed embodiments. Certain aspects of process 400 may be performed as part of operation 350 shown in FIG. 3, as discussed above. In some embodiments, process 400 may be performed by computing system 200 provided as part of reward identification system 130. In some embodiments, process 400 may be initiated upon receipt of a reward opportunity request message received from client device 120. In some embodiments, the reward opportunity request message may include spending information and one or more comparison parameters.

As part of operation 410, reward identification system 130 may receive or access spending data of a customer 110 associated with the received reward opportunity request message. Aspects of operation 410 may be performed by spending module 242 executed by one or more processors of computing system 200. In some embodiments, spending data may be received directly from customer 110, such as when customer 110 uploads historical spending information to reward identification system 130. In other embodiments, spending module 242 may use received spending information to access one or more financial service accounts associated with customer 110. For example, in some embodiments, spending module 242 may be configured to interface reward identification system 130 with a database 240 or one or more third party servers 150 to receive historical spending data associated with a customer 110. In some embodiments, historical spending data may be based on customer 110's use of one or more financial service accounts provided by a financial service provider associated with reward identification system 130. In these embodiments, spending module 242 may access historical spending data stored in database 240 of reward identification system 130, for example. In other embodiments, spending module 242 may be configured to access historical spending data associated with a third party financial service provider stored on a third party server 150, for example. In these embodiments, spending module 242 may establish a link to one or more third party servers 150 to receive historical spending data associated with customer 110.

In operation 420, which in some embodiments may be performed in parallel to operation 410, reward module 244 of computing system 200 may receive a plurality of financial service account terms and conditions. In some embodiments, reward module 244 may be configured to access terms and conditions information of one or more financial service accounts stored in database 240, for example. In some embodiments, database 240 may include a plurality of data records associated with a plurality of financial service accounts offered by one or more financial service providers. Each of the plurality of data records may include a set of data defining various terms and conditions of a reward program or reward offerings associated with the financial service account. In some embodiments, the received account terms and conditions may be based on one or more comparison parameters received in a reward opportunity request message from client device 120. For example, when client device 120 receives a comparison parameter that customer 110 is interested in a financial service account offering cash back rewards, reward module 244 may receive account terms and conditions associated with those financial service accounts that provide financial accounts with a cash back rewards program. In some embodiments, reward module 244 may be configured to receive account terms and conditions of financial service accounts that are highly related to the received comparison parameters to identify closely matching reward opportunities of financial service accounts.

In other embodiments, reward module 244 may also receive account terms and conditions of financial service accounts with other characteristics so as to identify reward opportunities of one or more other accounts that customer 110 may be interested in even though it may not closely match the comparison parameter(s). Thus, in some embodiments, reward module 244 may also receive account terms and conditions of one or more financial service accounts based on information other than the one or more received comparison parameters. In some embodiments, reward identification system 130 may be configured to identify reward opportunities of one or more financial service accounts based on historical spending information, for example. In some embodiments, reward module 244 may be configured to access received spending data and identify one or more characteristics of customer 110's spending habits. In some embodiments, reward module 244 may receive indexed spending data from indexing module 246 (described in greater detail below) to help identify one or more spending habits of customer 110. For example, reward module 244 may be configured to determine, based on received indexed spending data, that a significant percentage of customer 110's spending data is related to purchases at a particular merchant or service provider, or for particular goods such as groceries or gas. Reward module 244 may be configured to receive account terms and conditions of one or more financial service accounts that may provide a beneficial reward opportunity to customer 110 based on characteristics of customer 110's spending data.

In some embodiments, reward module 244 may be configured to maintain and update a plurality of data records associated with one or more financial service accounts that are stored in database 240, for example. Reward module 244 may be configured to crawl one or more third party servers 150, such as a web-server, to determine the terms and conditions information of one or more financial service accounts from, for example, websites associated with the one or more financial service providers. Reward module 244 may generate the database of data records in advance or separate from a received reward opportunity request message. In other embodiments, reward module 244 may be configured to access one or more third party servers in real-time based on one or more received comparison parameters, or based on an evaluation of the received spending data. In some embodiments, in response to a received reward opportunity request message, reward module 244 may receive account terms and conditions by both accessing database 240, for example, and accessing one or more third party servers for identifying terms and account information for additional financial service accounts that may not be included as part of database 240.

In some embodiments, the received account terms and conditions of one or more financial service accounts may include any information relevant for simulating reward earning opportunities based on historical spending data and/or spending forecast data. For example, exemplary account terms and conditions may specify the amount of an annual fee associated with a financial service account, the categories of purchases eligible for rewards, how rewards are determined, the amount of rewards offered for purchases in one or more categories of purchases eligible for rewards, spending limits, reward limits, and any other relevant information that may affect simulated or actual reward earning opportunities based on purchase, payment, or spending data.

In operation 430, indexing module 246 may be configured to index the received spending data based on categories of purchases, merchants, or any other characteristics that may be relevant for simulating reward earning opportunities of one or more financial service accounts. In some embodiments indexing module 246 may be configured to receive the plurality of account terms and conditions from reward module 244 to identify one or more categories or other characteristics of spending that may be indexed to enable a simulation of reward earning opportunities. Indexing module 246 may generate one or more data records of indexed spending data based on the received account terms and conditions. For example, in some embodiments, terms and conditions of one or more financial service accounts may conflict in the categorization of purchases. Indexing module 246 may thus generate any number of indexed data records to facilitate simulation of reward earning opportunities based on the received account terms and conditions.

In some embodiments, as part of operation 430, indexing module 246 may also index received spending data to identify one or more characteristics or patterns in customer 110's spending data, as similarly discussed above. For example, indexing module 246 may identify that customer 110 frequently purchases goods from a particular merchant, such as a retail store or gas station, or frequently travels on a particular airline or stays overnight at a particular hotel, etc. In some embodiments, indexing module 246 may help identify potential reward earning opportunities that may benefit customer 110 based on the customer's categories of spending including, for example, rewards opportunities associated with the particular airline, hotel, etc. that the customer frequents.

In operation 440, simulation module 248 may be configured to simulate one or more reward earning opportunities of one or more financial service accounts based on the indexed spending data and the account terms and conditions of the one or more financial service accounts. Simulation module 248 may be configured to determine the amount of rewards that would have been earned during a predefined period for each of a plurality of financial service accounts, based on customer 110's historical spending information. For example, simulation module 248 may analyze the indexed spending data to determine the amount of rewards that would have been earned based on the terms and conditions for each of a plurality of financial service accounts. Additionally, in some embodiments, simulation module 248 may be configured to generate an estimate or a projection of reward earning opportunities based in part on received forecast information supplementing the historical spending data. Simulation module 248 may provide the simulated reward earning opportunities for one or more financial service accounts to interface module 250, which may be configured to update an exemplary interface, such as that shown in FIG. 6, to include the simulated reward earning opportunities, as part of operation 470.

In some embodiments, simulation module 248 may also provide the simulated reward earning opportunities to score module 252, which may be configured to analyze the simulated reward earning opportunities to determine a reward value and comparison metric of the simulated reward earning opportunities. For example, the manner in which reward points are earned can vary considerably between each of the financial service accounts. One financial service account, for example, may offer 3 “points” for every dollar spent, whereas another may offer 1 “point” for every dollar spent. A raw point total determined for each of financial service accounts based on the simulated reward earning opportunities would tend to indicate that the first financial service account offers greater reward earning opportunities. The value of the reward points of the two financial service accounts, however, may differ drastically. For example, the redemption policies may be such that the second account offers greater value to customer 110, even though the raw reward points would seem to indicate otherwise. Accordingly, it may be beneficial to provide a comparison of a reward value of the reward earning opportunities between different financial service accounts. Additionally, in some embodiments, it may be beneficial to determine a comparison metric based at least in part on the reward value to provide an indication of a net benefit value. In some embodiments, the comparison metric may be used to compare a benefit value across one or more categories of rewards and reward options.

Score module 252 may be configured to determine a reward value based on one or more reward options. In the disclosed embodiments, reward options may generally refer to goods or services that may be redeemable using reward points or miles, for example. For example, in some embodiments, reward points may be used to redeem a gift card, or for travel vouchers or merchandise, etc. In some embodiments, score module 252 may be configured to determine a reward value of the simulated reward earning opportunities based on a received selection of one or more reward options. For example, customer 110 may interact with an exemplary interface of client device 120 such that client device 120 receives an input or selection of one or more reward options to be considered in determining a reward value. In some embodiments, score module 252 may also be configured to determine which of the reward options for a particular financial service account may offer the greatest value.

Score module 252 may be configured to access one or more third party servers 150 to receive data and any relevant information that may enable score module 252 to determine a reward value. For example, for a particular financial service account, available reward options may include the ability to use reward points for a stay at a particular hotel chain. Score module 252 may be configured to access relevant data stored by a third party server 150, for example, to determine how many nights may be redeemed using the simulated reward earning points. For example, third party server 150 may be a server associated with a reward program provider or financial service provider of the particular financial service account.

Continuing the above example, score module 252 may be configured to access information stored on a third party server 150 to determine that customer 110 would have earned two nights at a hotel chain by redeeming the simulated reward earning opportunity based on customer 110's historical spending information. In this example, the reward value of a particular reward option would correspond to two nights of hotel stays. Score module 252 may be configured to determine a reward value based on any number of predefined or customizable criteria. For example, extending the hotel chain example, score module 252 may be configured to determine the reward value based on an average number of points redeemable for one night stay, a lowest value of points redeemable for a one night stay, or other more detailed parameters defining a hotel stay in a particular city or of a particular reward level established by the hotel. Other parameters may also be considered in determining a potential reward value. In some embodiments, score module 252 may also determine the number of points, for example, that would be needed to extend the reward value to a third night, for example. This may be illustrated to customer 110 by a percentage, such as 2.5 nights, for example.

The above example is not limiting. Numerous other scenarios for calculating a reward value are contemplated by the present disclosure. Additionally, numerous other reward options may be used to determine a reward value. For example, a reward value may be determine based on the number of one-way or round trip flights for which the simulated reward earnings may be redeemed. Other reward values may be based on the number of movie tickets, the face value of a gift card, and many other redeemable reward options that are contemplated by the present disclosure.

In some embodiments, score module 252 may also be configured to generate a comparison metric based on the determined reward value, as part of operation 460. In some embodiments, a comparison metric may be generated that provides a common basis to compare reward benefits. In some embodiments, a comparison metric may include a metric or number based on a currency value of the determined reward value. For example, it may be beneficial for customer 110 to determine whether a financial service account offering points redeemable for an airline flight provides greater value than a financial service account offering points redeemable for a hotel stay. The comparison metric may also be used to compare the reward benefits across reward options and across reward categories. For example, reward identification system 130 may be able to determine whether a financial service account offering cash back rewards provides greater value than an airline reward account and a hotel reward account, based on an exemplary comparison metric.

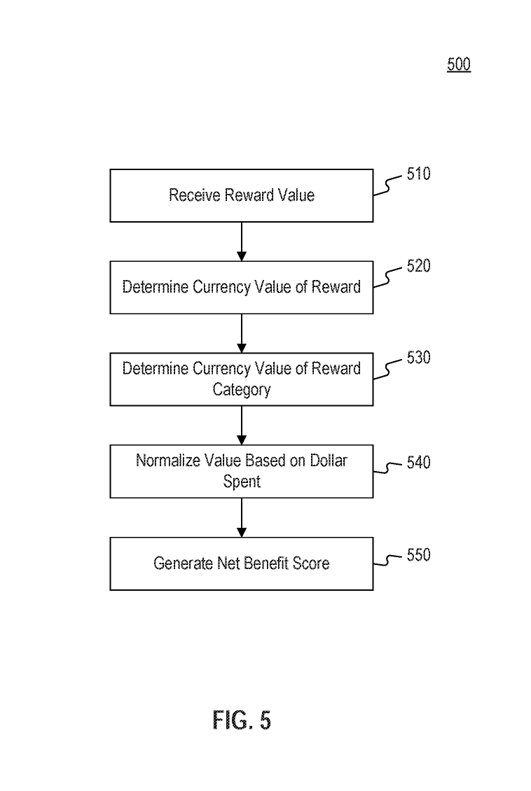

In some embodiments, score module 252 may access one or more third party servers 150 to determine a value of a reward option in terms of currency. In some embodiments, the currency value of a reward option may be based on an average value of the reward option or some other parameter. For example, for a financial service account offering points redeemable for an airline flight, a reward option value determined as part of operation 450 may have indicated that customer 110 would have earned two round-trip domestic flights. As part of operation 460, score module 252 may generate a comparison metric estimating a net benefit based at least in part on the reward value, a currency value of the reward value, and a value of the reward relative to a dollar spent earning the reward. The comparison metric may be provided as part of an updated interface, as part of operation 470. Additional details of operation 460 are described below with respect to process 500 in FIG. 5.

FIG. 5 illustrates an exemplary process 500 for generating a comparison metric, which in some embodiments may be identified as a net benefit score. As discussed above, the comparison metric of the exemplary embodiments enables a customer to identify a relative value of a number of reward offerings as determined with a common basis. In some embodiments, the common basis corresponds to a currency value of the reward relative to a dollar spent earning the reward.

As part of operation 510, score module 252 may receive a reward value determined as part of operation 450 discussed above with respect to FIG. 4. Based on the received reward value, score module 252 may determine a currency value of the reward, as part of operation 520. The currency value may be determined by accessing one or more third party servers 150 providing information regarding the currency value of a potential reward, such as an airline's booking website, for example. Extending the airline example above, score module 252 may determine a currency value of the two round-trip domestic flights determined as a reward value in operation 450. In some embodiments, the currency value may be based on the average cost of a round-trip domestic flight on the airline based on one or more parameters. For example, the average cost may be determined based on a departure location and an arrival destination, or based on an assumption of booking the flight one month in advance of the date of travel. In some embodiments, score module 252 may determine a currency value based on any one or more customizable parameters that may be input into an exemplary interface for example. Thus, in some embodiments, a determined currency value may be unique to customer 110 based on customer 110's location or travel preferences. In some embodiments, the customizable parameters may enable customer 110 to identify the most beneficial reward account to achieve a particular vacation goal for example, by identifying which of a plurality of reward accounts will provide the best value to earn a flight to a particular vacation destination.

In some embodiments, as part of operation 530, score module 252 may also be configured to determine a currency value based on the reward category. For example, where the reward category corresponds to travel points or airline miles, score module 252 may determine the currency value for a point or mile or other basis of the reward category. Score module 252 may determine a currency value of the reward category by dividing the currency value of the reward by the number of miles or reward points redeemed for the reward. Additionally, as part of operation 540, score module 252 may normalize the value of the reward category based on the amount of spending required to earn the reward points. For example, in some embodiments, score module 252 may generally determine the normalized value based on a dollar of spending by dividing the currency value of the reward category determined in operation 530 by the amount of spending necessary to earn a point. In some embodiments, additional algorithms may be implemented where, for example, a dollar spent generates different reward amounts based on a category of spending. Other calculations may also be performed based on the nature of a rewards program as is contemplated by the present disclosure. For example, in some embodiments, score module 252 may consider the cost of an annual fee associated with a financial account when determining the reward value based on a dollar spent as part of operation 540.

Additionally, in some embodiments, score module 252 may generate a comparison metric/net benefit score based on the result of operation 540. In some embodiments, operation 550 may convert the normalized value of a reward point based on a dollar spent to a metric more understandable to customer 110. In some embodiments, the comparison metric may be referred to as a net benefit score. For example, as shown in FIG. 6, and as discussed in further detail below, an area 626 of interface 600 may display a score for each financial service account displayed that may be easily compared to each of the reward program opportunities of one or more other financial service accounts. As part of operation 550, score module 252 may determine a net benefit score based on the total value of rewards that may have been earned using a particular financial service account based on the customer's historical spending information. For example, aspects of operations 510-540 determine a value based on a particular reward option, such as a domestic round-trip flight. As part of operation 550, score module 252 may consider other factors in determining a net benefit. Some exemplary factors may be based on or weighted according to certain user preferences concerning a particular bank or merchant, or metrics concerning customer satisfaction, or annual percentage rates, levels of spending that may result in increased reward benefits, or many other numerous considerations that may be considered when selecting a particular financial service account. A net benefit of the disclosed embodiments may be any score or other indication that provides a manner of comparing a benefit of a reward program in view of a common basis. While shown as numbers ranging from 120-180, in some embodiments, the net benefit score may be represented by a decimal or a range of numbers from 0-100, letter grade (e.g., A+ to F, or the like) or some other indicator distinguishing relative benefits of one or more financial service accounts.

FIG. 6 illustrates an exemplary interface 600 consistent with the disclosed embodiments. In some embodiments, interface 600 may be provided on a display of client device 120 or otherwise in communication with client device 120. The features and various aspects shown and described with respect to interface 600 are presented by way of example only. The features and functionality of the disclosed embodiments are not limited or defined by the functionality suggested by the illustrated interface. Numerous other configurations of an interface and nature of information displayed are contemplated by the present disclosure.

As shown, interface 600 may include a plurality of user selectable buttons, including links to other interfaces (not shown), drop-down menus, etc. for receiving customer input to customize the exemplary reward identification methods and a plurality of windows or window regions to display information to customer 110.

As discussed above, interface 600 may include a plurality of selectable buttons 602, 604, and 606 for receiving user input regarding historical spending information. Selection of button 602 may cause client device 120 to generate an interface for receiving a direct upload of historical spending information, selection of button 604 may cause client device 120 to generate an interface for linking one or more accounts of customer 110 to reward identification system 130 (e.g., allowing reward identification system 130 to access customer 110's historical spending information), and selection of button 606 may cause client device 120 to provide an interface for receiving additional spending forecast information to supplement historical spending information.

Interface 600 may include a general window region (not shown) for receiving other information that may be considered in the exemplary embodiments via, e.g., a text field. Additionally, interface 600 may include customer selectable fields for data to be considered in generating a comparison parameter as part of operation 340. For example, button 610 may allow client device 120 to receive a selected timeline for considering historical spending information. The timeline may correspond to one or more prior months or a year or more. Button 612 may enable client device 120 to filter spending information according to any one or more categories of spending selected, such as groceries, travel, gas, entertainment, etc. This feature may direct the reward identification processes to determine potential reward opportunities for a specific spending habit, such as to identify which financial service account provides a greater benefit specific to gas purchases, for example. Button 614 may allow client device 120 to receive identification information for one or more accounts from which historical spending information may be accessed for the exemplary reward identification processes. In some embodiments, interface 600 may include a display region 616 graphically displaying historical spending information based on one or more of the customer inputs provided via buttons 610, 612, and 614 for example.

In some embodiments, interface 600 may include a plurality of window regions, 622, 624, and 626 associated with an identifier of a particularly financial service account shown in region 620 for displaying results of an exemplary reward identification process consistent with the disclosed embodiments. For example, region 622 may display simulated reward earning opportunities based on the results of operation 440 described above. The simulated reward earning opportunities may display one or more of the reward earning opportunities that would have been realized based on the historical spending information and a projection of reward earning opportunities in view of received forecast information supplementing the historical spending information. Window region 624 may display one or more reward options offered by the particular financial service account that may be selectable by customer 110 to further determine a reward value of a desired option, as described above with respect to operation 450. Window region 626 may display a comparison metric or net benefit score of the simulated reward program as described above with respect to operation 460 and process 500 shown in FIG. 5.

In some embodiments, interface 600 may include one or more selectable buttons 628 that may provide a link to apply for the respective financial service account. One or more of buttons 628 may be associated with a link to one or more of third party servers 150 associated with one or more financial service providers accessible via network 140, for example, to direct client device 120 to a registration website, API, etc. for the desired financial service account of the financial service provider.

In some embodiments, interface 600 may include an additional window 630 that may include a number of customer selectable buttons to allow client device 120 to further customize the exemplary reward identification processes based on input received from customer 110. For example, as shown, client device 120 may customize a reward comparison specific to a particular reward category (points, miles, cash back, etc.), a particular bank or financial service provider, whether an annual fee is applied, whether forecast information is to be considered, and/or one or more reward options (gift cards, vouchers, merchandise, flights, hotels, etc.). Client device 120 may be configured to receive a selection of any one or more of these customizable options to narrow a particular reward identification process.

In some embodiments, window region 632 may be provided to rank one or more financial service accounts based on a net benefit score generated from a simulated reward earning opportunity according to the disclosed embodiments. In some embodiments, region 632 may display a rank of one or more financial service accounts based on specific customer input comparison parameters. In other embodiments, region 632 may also display a ranking of one or more other financial service accounts that may be of interest to customer 110 based on historical spending information or forecast information, for example.

The specific examples provided throughout the disclosure are provided to help understand the context of the disclosed embodiments and are not meant to limit the disclosed embodiments. Numerous other examples have been omitted for conciseness but would be evident based on the understanding of one of skill in view of the present disclosure.

Additionally, the above disclosure may be extended to provide a real-time reward identification process to determine whether customer 110 is realizing the benefit of a particular reward account. For example, one or more of the financial service accounts identified in region 620 may correspond to a current financial service account of customer 110. Interface 600 may thus be implemented to enable customer 110 to compare his or her current reward earning opportunities with the reward earning opportunities of one or more other financial service accounts. Interface 600 may be configured to make real-time recommendations for one or more other financial service accounts having more beneficial reward earning opportunities, for example. Reward identification system 130 may be configured to continuously monitor customer 110's spending information and provide real-time recommendations to customer 110 regarding one or more reward earning opportunities. The real-time recommendations may be provided via a notification to client device 120 associated with customer 110. Such notifications may include an in-app alert, an e-mail, text message or any other suitable means for communicating a recommendation to customer 110.

In some embodiments, real-time recommendations may include information regarding another financial service account that may be beneficial to customer 110 based on customer 110's current spending habits. For example, reward identification system 130 may provide an indication identifying another financial service account that may result in increased reward earning opportunities. As described above, the recommendation may be based on one or more comparison parameters. In other embodiments, a real-time recommendation may identify certain spending habits that may result in increased reward earning opportunities. For example, reward identification system 130 may be configured to remind or identify for customer 110 that a previous purchase may have earned greater rewards if made at a particular merchant, made before the end of the month, made with a particular financial service account, etc. Other recommendations may also include identification of amount of spending needed to reach a reward goal or reward bonus level, for example.

Additionally, in other embodiments where, for example, reward identification system 130 is associated with a particular financial service provider, reward identification system 130 may be configured to offer one or more financial service accounts with the financial service provider having competitive terms, as may be determined based on a comparison with one or more other financial service accounts. In these embodiments, a financial service provider associated with reward identification system 130 may be enabled to dynamically adjust terms and conditions or otherwise generate financial service account terms and conditions based on the comparison with one or more other financial service accounts. In some embodiments, reward identification system 130 may dynamically adjust certain terms and conditions on a customer by customer basis based on one or more comparison parameters, for example.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which are non-exclusive. For example, aspects of the disclosed embodiments are described as being associated with data stored in memory, and one skilled in the art will appreciate that these aspects can be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

What is claimed is:

1. A system for simulating reward opportunities of a plurality of reward accounts, comprising:
one or more memory devices storing instructions provided as part of a reward simulating application; and
one or more processors configured to execute the instructions to:
generate an interactive graphical user interface for display to a user of a computing device;
access spending information corresponding to a plurality of transactions completed using a financial account associated with the user;
access reward term information corresponding to a plurality of reward accounts associated with a comparison parameter based on received user input of one or more comparison parameters;
index the spending information according to one or more categories of spending based on the reward term information for each of the plurality of reward accounts;
simulate a reward opportunity for each of the plurality of reward accounts based on the indexed spending information and the reward term information;
generate a comparison metric for each of the plurality of reward accounts based in part on the reward term information and the simulated reward opportunity, the comparison metric identifying a common basis for comparison among the plurality of reward accounts; and
update the graphical user interface to display the comparison metrics and information corresponding to the simulated reward opportunities.

2. The system of claim 1, wherein at least one of the plurality of reward accounts corresponds to a reward account other than the financial account used in completing the plurality of transactions.

3. The system of claim 1, wherein the one or more processors are further configured to execute the instructions to:
receive user input, via the graphical user interface, including forecast spending information;
index the forecast spending information according to one or more categories based on the reward term information for each of the plurality of reward accounts; and
simulate a reward opportunity for each of the plurality of reward accounts based on the indexed forecast spending information and the reward term information.

4. The system of claim 1, wherein the comparison metric is generated based on a user selected reward option identified as part of the reward term information.

5. The system of claim 4, wherein the comparison metric is based on a currency value of the selected reward option.

6. The system of claim 1, wherein the spending information is accessed from uploaded information received via the graphical user interface.

7. The system of claim 1, wherein the spending information is accessed from the financial account using credential information received from the user to link the financial account with the reward simulating application.

8. The system of claim 1, wherein the graphical user interface is configured to receive user input to filter a subset of the accessed spending information to be used to simulate the reward opportunity.

9. The system of claim 8, wherein the graphical user interface is configured to receive a user input to filter the accessed spending information based on a category of spending.

10. The system of claim 8, wherein the graphical user interface is configured to receive a user input to filter the accessed spending information based on a selected timeframe.

11. The system of claim 1, wherein the graphical user interface is configured to receive user input for selecting the plurality of reward accounts based on a reward category.

12. A computer-implemented method for simulating reward opportunities of a plurality of reward accounts, comprising:
generating an interactive graphical user interface for display to a user of a computing device;
accessing spending information corresponding to a plurality of transactions completed using a financial account;
accessing reward term information corresponding to a plurality of reward accounts associated with a comparison parameter based on received user input of one or more comparison parameters;
indexing, by one or more processors, the spending information according to one or more categories of spending based on the reward term information for each of the plurality of reward accounts;
simulating, by the one or more processors, a reward opportunity for each of the plurality of reward accounts based on the indexed spending information and the reward term information;
generating, by the one or more processors, a comparison metric for each of the plurality of reward accounts based in part on the reward term information and the simulated reward opportunity, the comparison metric identifying a common basis for comparison among the plurality of reward accounts; and
updating, by the one or more processors, the graphical user interface to display the comparison metrics and information corresponding to the simulated reward opportunities.

13. The method of claim 12, further comprising wherein at least one of the plurality of reward accounts corresponds to a reward account other than the financial account used in completing the plurality of transactions.

14. The method of claim 12, further comprising:
receiving, via the graphical user interface, forecast spending information;
indexing the forecast spending information according to one or more categories based on the reward term information for each of the plurality of reward accounts; and
simulating a reward opportunity for each of the plurality of reward accounts based on the indexed forecast spending information and the reward term information.

15. The method of claim 12, wherein the comparison metric is generated based on a user selected reward option identified as part of the reward term information.

16. The method of claim 15, wherein the comparison metric is based on a currency value of the selected reward option.

17. The method of claim 12, wherein the graphical user interface is configured to receive user input to filter a subset of the accessed spending information to be used to simulate the reward opportunity based on a selected category of spending or a selected timeframe.

18. The method of claim 12, wherein the graphical user interface is configured to receive user input for selecting the plurality of reward accounts based on a reward category.

19. A non-transitory computer-readable medium storing instructions executable by a processor to cause the processor to perform operations comprising:
generating an interactive graphical user interface for display to a user of a computing device;
accessing spending information corresponding to a plurality of transactions completed using a financial account;
accessing reward term information corresponding to a plurality of reward accounts associated with a comparison parameter based on received user input of one or more comparison parameters;
indexing the spending information according to one or more categories of spending based on the reward term information for each of the plurality of reward accounts;
simulating a reward opportunity for each of the plurality of reward accounts based on the indexed spending information and the reward term information;
generating a comparison metric for each of the plurality of reward accounts based in part on the reward term information and the simulated reward opportunity, the comparison metric identifying a common basis for comparison among the plurality of reward accounts; and
updating the graphical user interface to display the comparison metrics and information corresponding to the simulated reward opportunities.

20. The non-transitory computer-readable medium of claim 19, the operations further comprising:
receiving, via the graphical user interface, forecast spending information;
indexing the forecast spending information according to one or more categories based on the reward term information for each of the plurality of reward accounts; and
simulating a reward opportunity for each of the plurality of reward accounts based on the indexed forecast spending information and the reward term information.
